(19) United States
(12) Patent Application Publication
(10) Pub. No.: US 2022/0210587 A1
(43) Pub. Date: Jun. 30, 2022

(54) HEARING AID HAVING TINNITUS MASKING FUNCTION

(71) Applicant: ZHENGDONG HUANG, YANCHENG (CN)

(72) Inventor: ZHENGDONG HUANG, YANCHENG (CN)

(21) Appl. No.: 17/609,006

(22) PCT Filed: Jan. 21, 2020
(86) PCT No.: PCT/CN2020/073646

§ 371 Date: Nov. 5, 2021

(30) Foreign Application Priority Data
May 27, 2019 (CN) 201910444097.8

(51) Int. Cl. H04R 25/00

(52) U.S. Cl. CPC H04R 25/75; H04R 25/70

(57) ABSTRACT

A hearing aid having tinnitus masking function is disclosed, comprising a hearing aid with a audio signal processing unit and a narrowband noise generator unit. The hearing aid is further provided with a network communication module for network connection between the hearing aid and a control terminal, by means of a wired or wireless manner. By adding a narrowband noise generator mutually independent from the audio signal processing unit, and by using debugging software of a computer terminal or mobile phone terminal to issue instructions to change various parameters of the narrowband noise generator through network transmission, hearing impaired persons who have used the disclosed can improve hearings to promote their communication skills, and corresponding narrowband noises are controlled simultaneously to mask the tinnitus, thereby distracting patients' attentions from the tinnitus, and ensuring that the hearing impaired persons can effectively use the hearing aids to communicate with others.

### TECHNICAL FIELD

The present disclosure relates to the field of hearing aids, in particular to a hearing aid having tinnitus masking function.

### BACKGROUND

Hearing aid is a common auxiliary hearing device, which can amplify an original inaudible sound, and then send the amplified sound to the auditory center in the brain through a residual hearing of a hearing impaired person, so that the hearing impaired person can perceive the sound, thus can communicate with others normally.

Since the hearing impaired person suffers from a malfunction in his/her auditory system, resulting in that many diseases that affect the auditory system appear with different pathological changes accordingly, mainly a tinnitus, which is manifested as a person subjectively has a sound sensation in the ear or skull, while there is no corresponding external sound source or electrical stimulation.

However, an existing hearing aid is a device that only amplifies a sound and processes the sound. Since most hearing impaired persons have suffered from different degrees of tinnitus, which will have some influences on the communications between the hearing impaired persons and others. Besides, the tinnitus and hearing impairments need to be treated separately, which brings inconveniences to the hearing impaired persons.

### SUMMARY

The present disclosure provides a hearing aid having tinnitus masking function, which has the advantages of improving hearings of a hearing impaired person while distracting his or her attentions from the tinnitus, thus solves the technical problems mentioned in the prior art.

The present disclosure provides a hearing aid having tinnitus masking function, comprising a hearing aid with an audio signal processing unit and a narrowband noise generator unit, wherein the hearing aid is further provided with a network communication module that is used for network connection between the hearing aid and a control terminal, and the network connection manner between the hearing aid and the control terminal is a wired or wireless manner; the control terminal is provided with a debugging software, and parameters of the narrowband noise generator unit of the hearing aid are modified on the debugging software of the control terminal.

Preferably, the narrowband noise generator unit is provided with several pieces of tinnitus masking sound, and the pieces of tinnitus masking sound can be selected singly, or multiple pieces of tinnitus masking sound can be selected for mixing.

Preferably, the control terminal is a computer terminal or a mobile phone terminal, the control terminal is provided with the debugging software used for modifying the parameters of the narrowband noise generator unit, and the debugging software is used to set the narrowband noise generator unit.

Preferably, the debugging software of the control terminal has an independent volume adjusting function for the tinnitus masking sound.

Preferably, the debugging software of the control terminal has a function of turning on and off the tinnitus masking sound.

Preferably, masking modes of the narrowband noise generator unit comprise a normal mode, a hearing aid mode, a pure-tone audiometer mode, and a walkman mode.

The present disclosure has the following beneficial effects:

In the hearing aid having tinnitus masking function, by adding a narrowband noise generator mutually independent from the audio signal processing unit within the hearing aid, and by using debugging software of a computer terminal or mobile phone terminal to issue instructions to change various parameters of the narrowband noise generator through network transmission, the hearing impaired persons who have used the hearing aid can improve hearings to promote their communication skills, and corresponding narrowband noises are controlled simultaneously to mask the tinnitus, thereby distracting patients' attentions from the tinnitus, and ensuring that the hearing impaired persons can effectively use the hearing aids to communicate with others. After a long-term stimulation training, the memory of the tinnitus in the auditory center is erased and the plasticity of tinnitus is destroyed, so that the tinnitus is relieved and even disappeared.

In the hearing aid having tinnitus masking function, several pieces of masking sound are available for single or multiple selection, so that the hearing impaired persons can select according to their requirements, which is suitable for different hearing impaired persons. Meanwhile, multiple groups of masking noises can also generate residual suppression, which can further improve the masking effects. Aiming at different intensities of tinnitus, the tone of the masking sound can be adjusted by the software on the control terminal in real time, so that the masking effect is always kept in the best state.

### BRIEF DESCRIPTION OF THE DRAWINGS

FIG. 1 is a schematic view of a system according to the present disclosure.

FIG. 2 is a schematic view of a software interface of a control terminal according to the present disclosure.

### DETAILED DESCRIPTION OF PREFERRED EMBODIMENTS

The technical solutions in the embodiments of the present disclosure will be clearly and completely described hereafter in conjunction with the accompanying drawings in the embodiments of the present disclosure. Obviously, the described embodiments are merely a part of the embodiments of the present disclosure, rather than all the embodiments. Based on the embodiments of the present disclosure, all other embodiments obtained by those of ordinary skill in the art without creative work shall fall within the protection scope of the present disclosure.

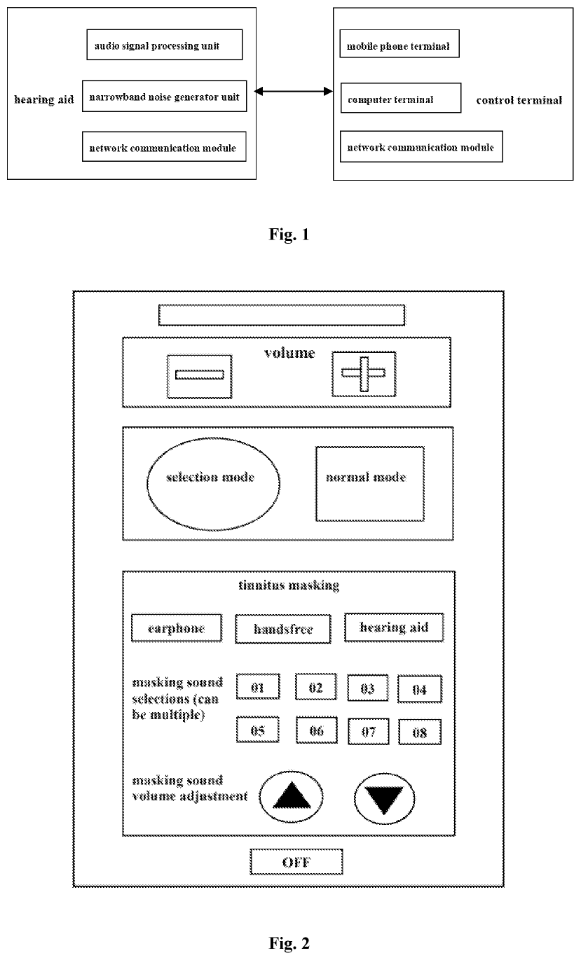

Please refer to FIG. 1 to FIG. 2, a hearing aid having tinnitus masking function is provided, which comprises a hearing aid with an audio signal processing unit and a narrowband noise generator unit. The audio signal processing unit amplifies a sound and then sends the amplified sound to an auditory center of the brain of a hearing impaired person, so that the hearing impaired person can perceive the normal sound to complete normal communications. The narrowband noise generator unit within the hearing aid independent from the audio signal processing unit uses the noise generated by the narrowband noise generator to select narrowband noises corresponding to a part of capillary cells with enhanced activities, for exciting control the efferent nerves of the part of capillary cells, thereby reducing the spontaneous activities of the capillary cells and making them recover to normal. After a period of stimulation training, the hearing impaired person can recover part or all of the excitability of the efferent nerves, thus to reduce abnormal spontaneous firing activities or return to normal spontaneous firing activities, so as to erase the memory of tinnitus in the auditory center and to destroy plasticity of tinnitus, thus the tinnitus is relieved or even disappeared. Therefore, the hearing impaired person can get hearing compensations, and meanwhile, the corresponding narrowband noises are utilized to mask the tinnitus, so the hearing impaired person can communicate with others normally. The narrowband noise generator unit can be provided with several pieces of tinnitus masking sound, and the tinnitus masking sound pieces can be selected singly, or multiple pieces of tinnitus masking sound can be selected for mixing. Various pieces of masking sound are available to be selected, which is suitable for all kinds of tinnitus patients. The masking noise also produces residual suppression, thus the masking effect is further improved. The hearing aid is further provided with a network communication module that is used for network connection between the hearing aid and a control terminal, and the network connection manner between the hearing aid and the control terminal is a wired or wireless manner. The control terminal is provided with a debugging software, wherein by turning on the debugging software of the computer terminal or mobile terminal manually, a software interface is popped up. By clicking a volume button of the software interface, the volume of the amplified sound of the hearing aid audio signal processing unit can be adjusted to ensure that the hearing impaired person can perceive an appropriate sound. By clicking a selection mode button, an appropriate mode is selected according to the specific situation, and by clicking the number buttons on the masking sound selections area, different types of masking sounds are selected. By clicking two buttons for adjusting the volume of the masking sound, the masking sound is adjusted to a suitable level according to the specific situation of the user, which can mask the tinnitus sound without disturbing the sound amplified by the audio signal processing unit, thereby ensuring that the hearing impaired person can perceive the normal sound. By clicking OFF on the software interface, the hearing aid is directly turned off. When the hearing aid is not in use, turning off its functions to save the power of the hearing aid, and by clicking OFF again the hearing aid can be turned on again. A series of modifications to the parameters of the narrowband noise generator unit of the hearing aid can be carried out on the debugging software of the control terminal. The control terminal is a computer terminal or mobile phone terminal, and the control terminal is provided with the debugging software used for modifying the parameters of the narrowband noise generator unit, and the debugging software is used to set the narrowband noise generator unit. By operating on the debugging software of the computer terminal or mobile phone terminal, the parameters of the noise generator can be changed by means of the network transmission, so that different degrees of tinnitus in the hearing impaired persons are treated and recovered. The debugging software of the control terminal has a function of turning on and off the masking sound of tinnitus, so that the hearing impaired person with disappeared tinnitus or without tinnitus can turn off the tinnitus masking function, and the hearing impaired person with tinnitus can turn on the tinnitus masking function.

The debugging software of the control terminal has an independent volume adjusting function for the tinnitus masking sound. As the hearing impaired person uses the hearing aid having tinnitus masking function, the tinnitus phenomenon has been continuously relieved, and the tinnitus intensity has been changed accordingly. Aiming at different intensities of tinnitus, a tone of the masking sound can be adjusted in real time through the software of the control terminal, so that the masking effect is always kept in the best state, which is further conducive to relieving or eliminating the tinnitus of the hearing impaired person.

Masking modes of the narrowband noise generator unit comprise a normal mode, a hearing aid mode, a pure-tone audiometer mode, and a walkman mode. Due to the intricacies of tinnitus in the hearing impaired person, according to different tinnitus situations, an appropriate masking mode is selected through the software of the control terminal to ensure that the tinnitus is effectively and maximally masked. The hearing aid mode is suitable for the hearing impaired person whose main tone of the tinnitus is below 4000 Hz, accompanied by tinnitus and moderate hearing loss; the pure-tone audiometer mode is suitable for the hearing impaired persons with various tones of the tinnitus; and the walkman mode is suitable for hearing impaired persons whose main tone of the tinnitus is below 4000 Hz. Hearing impaired person can use the pure-tone audiometer to output a narrowband noise matched with the tone of tinnitus, which makes the treatment effect of tinnitus better.

It should be noted that, in the present disclosure, the relational terms such as first and second are only used to distinguish one from another entity or operation without necessarily requiring or implying any actual such relationship or order between such entities or operations. Besides, the terms “include”, “comprise” or any other variants thereof are intended to cover non-exclusive inclusion, so that a process, method, article or device of including a series of elements not only includes those elements, but also includes other elements that are not explicitly listed, or also includes the elements inherent to the process, method, article or device.

Although the embodiments of the present disclosure have been illustrated and described, those of ordinary skill in the art should understand that various changes, modifications, substitutions and variations can be made to these embodiments without departing from the principles and spirits of the present disclosure, and the scope of the present disclosure is defined by the append portioned claims and their equivalents.

What is claimed is:

1. A hearing aid having tinnitus masking function,
comprising a hearing aid with an audio signal processing unit and a narrowband noise generator unit,
wherein the hearing aid is further provided with a network communication module that is used for network connection between the hearing aid and a control terminal,
and the network connection manner between the hearing aid and the control terminal is a wired or wireless manner.

2. The hearing aid having tinnitus masking function according to claim 1, wherein the control terminal is provided with a debugging software, and parameters of the narrowband noise generator unit of the hearing aid are modified on the debugging software of the control terminal.

3. The hearing aid having tinnitus masking function according to claim 1, wherein the narrowband noise generator unit is provided with several pieces of tinnitus masking sound, and the pieces of tinnitus masking sound can be selected singly, or multiple pieces of tinnitus masking sound can be selected for mixing.

4. The hearing aid having tinnitus masking function according to claim 1, wherein the control terminal is a computer terminal or a mobile phone terminal, the control terminal is provided with the debugging software used for modifying the parameters of the narrowband noise generator unit, and the debugging software is used to set the narrowband noise generator unit.

5. The hearing aid having tinnitus masking function according to claim 4, wherein the debugging software of the control terminal has an independent volume adjusting function for the tinnitus masking sound.

6. The hearing aid having tinnitus masking function according to claim 4, wherein the debugging software of the control terminal has a function of turning on and off the tinnitus masking sound.

7. The hearing aid having tinnitus masking function according to claim 1, wherein masking modes of the narrowband noise generator unit comprise a normal mode, a hearing aid mode, a pure-tone audiometer mode, and a walkman mode.
